(19) United States
(12) Patent Application Publication
(10) Pub. No.: US 2013/0163034 A1
(43) Pub. Date: Jun. 27, 2013

(54) VENDOR SELECTION METHOD AND SYSTEM FOR WIDE FORMAT PRINTING

(71) Applicants: Lewis S. Snow, La Crescenta, CA (US); Arazik Khachatrian, Pittsford, NY (US)

(72) Inventors: Lewis S. Snow, La Crescenta, CA (US); Arazik Khachatrian, Pittsford, NY (US)

(73) Assignee: XEROX CORPORATION, Norwalk, CT (US)

(21) Appl. No.: 13/337,635

(22) Filed: Dec. 27, 2011

(51) Int. Cl. G06K 15/02

(52) U.S. Cl. 358/1.15

(57) ABSTRACT

A wide format digital printing system communicates with vendor specification and price databases to determine which vendors are capable of performing a wide format digital printing project. When the system determines which vendors have presses that are capable of performing the job, the system automatically determines a price for the job based on vendor rate card data for individual aspects of the job, such as number of impressions, substrate types, and finishing activities. The price is presented to the buyer for one or more vendors, and the buyer may select a vendor based on the presented price and vendor information.

### BACKGROUND

Wide format digital (WFD) printing is one of the most rapidly developing print technologies. Wide format printers are generally known to those of skill in the art as those having an ability to print on a substrate that has a width of at least 17 inches. Most wide format printers can print on substrates having a width of 17 inches to as high as 100 inches. Printers that can print on substrates having a width of over 100 inches are sometimes referred to as super-wide format printers or grand format printers. Often, WFD prints can be made on a variety of substrates, such as paper, cardboard, cloth, vinyl or other disparate materials.

This document describes methods and systems that may improve a print service provider's delivery of WFD print-related services.

### SUMMARY

In an embodiment, a system for selecting a press for wide format digital printing, includes a price engine, a vendor database, and a vendor rate database. The price engine receives a buyer's request for a wide format digital print job. The system determines a set of job specifications for the print job, accesses a vendor database to identify one or more vendor presses that have vendor press specifications that correspond to the job specifications. For each identified vendor press, the system obtains vendor rate card data from the vendor rate database and uses the vendor rate card data and at least a portion of the job specifications to determine a price for performing the print job. The system presents the price and vendor information to the buyer via a buyer interface. The buyer may use the buyer interface to select from the available options and have the job printed on the selected vendor press.

In some embodiments, the system also includes a sourcing process service that includes a vendor interface through which a vendor may submit updated vendor specifications to the vendor database. The vendor also may have the ability to submit updated vendor rate card data to the vendor database through the vendor interface.

When identifying presses, the system may compare the job specifications to the vendor press specifications for multiple presses in the vendor database to identify at least one press having press profile data and substrate profile data that matches at least a portion of the job specifications. The press profile data may include, for example supported media size, number of ink colors used for full color printing, and/or pixel density. The substrate profile data may include, for example, supported wide format substrate type, supported ink type for the substrate, and/or supported image quality for the substrate.

When determining a price for the job on a candidate press, the system may use the job specifications to identify a set of services. The services may include a number of ups, such as an optimum number of ups. The system will then access the vendor rate card data for an identified press, return a unit price for each of the services, and total the unit prices to yield a total price. Any of the unit prices, or the total price, may be adjusted may one or more adjustment factors.

### BRIEF DESCRIPTION OF THE DRAWINGS

FIG. 1 is a block diagram showing elements of a system for ordering and/or determining the price of a wide format digital (WFD) print job.

FIG. 2 is a flow diagram illustrating a process for selecting a print shop and related equipment to perform a WFD print job.

FIG. 3 is a flow diagram illustrating a method of determining a signature for printing a WFD print job on a press.

FIG. 4 depicts a block diagram of internal hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this application, the following terms shall have the respective meanings set forth below:

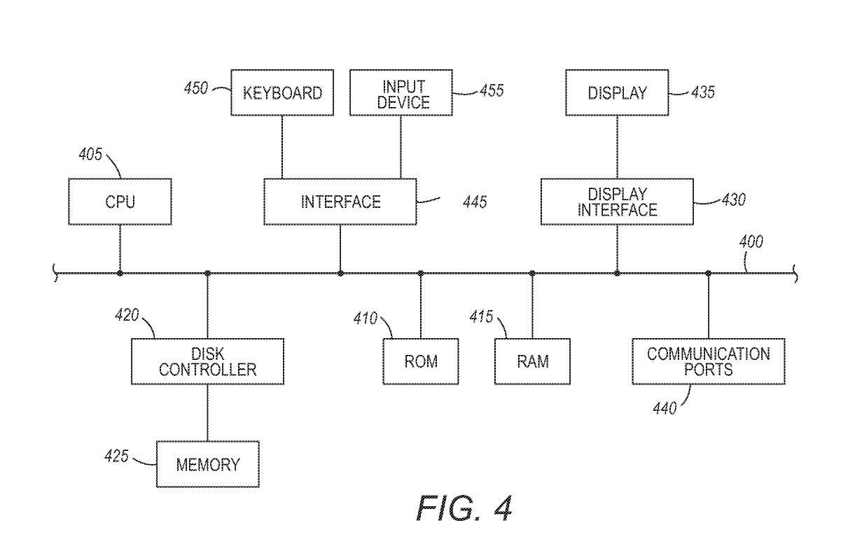

A “computing device” or a “processor” refers to a computer or other machine that performs one or more operations according to one or more programming instructions. A computing device or processor is described in reference to FIG. 4.

“Electronic communication” refers to any form of electronic sharing of data and/or instructions, including physically connected or wireless communication, as well as communication that is direct or indirect via one or more networks.

A “press,” “printer” or “printing device” is an item of equipment that can receive a data file or set of electronic instructions and impart alphanumeric text, symbols and/or graphics on a substrate based on the information contained in the data file or instructions. A printing device also may be able to perform one or more additional print-related functions, such as scanning, copying, collating or binding. In such a situation, the print device may sometimes be referred to as a “multifunction device.”

A “print job” refers to a sequence of operations that are performed to prepare one or more documents using one or more printing devices. Examples of operations may include printing, cutting, binding, and/or the like.

A “print requester” or “buyer” refers to an individual or business that submits a request to have a document printed. A print requester may request a print job via a computing device such as a desktop computer, a laptop computer, a mobile device, such as a smart phone or other handheld device, a wearable computer or similar devices.

A “print shop” refers to an entity that includes a plurality of document production resources, such as printers, cutters, collators and the like. A print shop may be a freestanding entity, including one or more printing devices, or it may be part of a corporation or other entity. Additionally, a print shop may communicate with one or more servers by way of a local area network or a wide area network, such as the Internet, the World Wide Web or the like.

A “vendor” or “print supplier” may refer to an owner or operator of a printing device that is capable of performing print jobs.

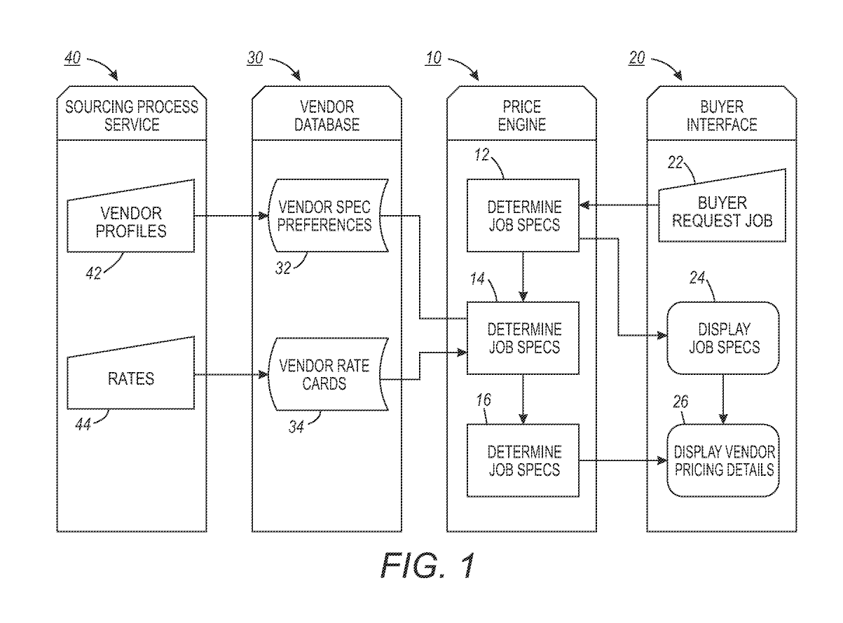

FIG. 1 is a block diagram showing elements of a system for ordering and/or determining the price of a wide format digital (WFD) print job. The central element of the system is a price engine 10, which is a computing device, software module, or other hardware or software item that determines a price and identifies suitable presses for a WFD print job based on various inputs. The price engine 10 is in electronic communication with a buyer interface 20, which is a user interface through which a potential buyer of WFD print products or services may request, order and receiving pricing information about one or more print jobs. The buyer interface may be a stand alone computing device, mobile electronic device (e.g., laptop, tablet or smartphone), or a portion of a computing device such as a touch screen and/or keyboard. The price engine is also in electronic communication with one or more vendor databases 30. Each vendor database 30 is a tangible, computer-readable tangible medium that holds print job specification and pricing data for multiple vendors. The vendor databases 30 may be in electronic communication with one or more sourcing process services 40, which are user interfaces, computing devices, or communications devices that receive data from the vendors.

As shown in FIG. 1, when a buyer initiates a request 22 for a WFD print job, the price engine 10 may implement programming instructions that determine a set of specifications 12 for the job. Any or all of the specifications may be received from the buyer or determined by any suitable methods. Exemplary methods of determining specifications for a print job are disclosed in U.S. Patent Application Pub. No. 2011/0149337; U.S. Patent Application Pub. No. 2001/0116133; and U.S. Pat. No. 7,983,792, the relevant disclosures of which are all incorporated herein by reference. The specifications may be returned to the buyer interface for display to a user 24. If so, in some embodiments the user may review the information to confirm accuracy and/or determine whether other changes are desired. If so, the buyer may be able to change the job request 22.

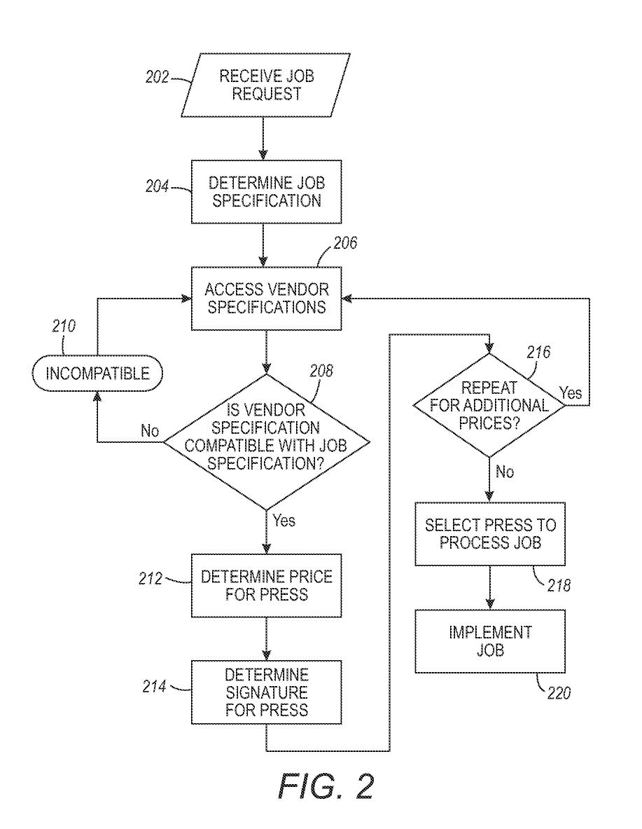

When the specifications are determined, the price engine 10 may access the vendor specifications 32 and the vendor rate card 34 portions of the vendor databases 30 to perform a press type determination 14 that identifies the available vendor and/or vendor equipment that can support the buyer's request. Exemplary steps of this press step determination process will be described in more detail in the discussion of FIG. 2 below. The price engine may use this information to determine the service price for one or more of the vendors, and it will send that data to the buyer interface 20 for presentation 26 to the user via display, printing on a substrate, storage in a memory, or audio presentation.

The vendor specification 32 may be updated by a sourcing process service 40 that receives vendor profile data 42. The vendor profile data 42 may be input by the vendors themselves through a user interface, collected by one or more representatives, or gathered in any suitable automated fashion. Similarly, the vendor rate cards, which store data relating to various job functions for each vendor, may be updated by a sourcing process service 40 that receives vendor rate data 44. The vendor profile data 42 may be provided by the vendors themselves through a user interface, collected by one or more representatives, or gathered in any suitable automated or manually-input fashion.

The vendor specifications 32 are vendor-specific parameters and that reflect the capabilities and preferences of a print service provider. Vendor specifications may be categorized using categories such as press profile data, substrate profile data, and finishing data. Each vendor's press profile data is a set of parameters that describe the print capabilities and actual print devices that the vendor has available. The parameters together may make up a “virtual press,” which may be a model or press profile having characteristics that reflect the vendor's actual print shop equipment and configuration.

Press profile data may include parameters such as:
Manufacturer.
Model.
Number of available presses within each “virtual press”.
Press Input (e.g., rolls, cut sheets, or both).
Supported media sizes, including but not limited to minimum and maximum width and length parameters to insure a job spec can fit on a specific press. (Due to the carriage width of presses, feeding methodologies, and other mechanical factors, different model presses have different characteristics that limit what can be fed through the press. This information helps determine if the press can support the specified project size).
Supported Rolls Width. (Roll-based substrates may be available in many roll widths, such as 40 inch, 60 inch, 72 inch, etc.). This information helps identify whether the press can support the specified project substrate width.
Supported Cut Sheet Width/Length (Cut sheet-based substrates come in many available widths and lengths, such as 24×30 inches, 26×40 inches, etc.). This information helps identify whether the press can support the specified project substrate width and length.
Supported Ink Types, (including but not limited to standard inks, fade-resistant inks, ultra violet inks (including base material).
Ink quality factors, such as:
   Number of ink colors used for full color printing; and
   Different model presses use different number of individual ink colors to produce a full color print, breaking apart some or all of the commonly-known four-color CMYK (Cyan, Magenta, Yellow, Black) ink set into light and dark versions of the base color;
Ability to match special colors. (Different model presses have capacity for additional cartridge positions to allow use of special colors not achievable using the CMYK process—e.g., silver, gold, fluorescents, etc.).
Ink coverage (percentage of image area covered with ink), for example:
   0.8 for heavy coverage,
   0.5 for medium coverage, or
   0.25 for light coverage.
Pixel density, such as dot per inch (DPI), settings for output resolution (image quality).
   Different presses have different maximum and DPI settings, which produce different quality outputs. The higher a DPI setting the higher quality and more refined the output image. A 300 DPI setting would produce a draft-quality output, a 1200 DPI setting would produce much higher quality.
Minimum and/or maximum number of impressions, which indicates whether the equipment can produce the requested quantity of materials ordered.
Maximum throughput (e.g., square inches/millimeters per hour) at specific DPI or other density settings.

For each virtual press identified in the press profile, substrate profile data may include data such as:
Supported Substrate Types: these may be selected from a list of wide format substrate options that can be fed into the specific virtual press, including, but not limited to:
   Standard uncoated papers;
   Standard coated papers;
   Specialty photo gloss papers;
   Clear or colored mylars and other plastics; and
   Cloth and vinyl banner materials.
For each supported substrate selected, information specific to that substrate such as:
   Substrate Availability (e.g., rolls, cut sheet, or both).
      If rolls are available: widths.
      If cut sheets are available: sizes (widths and lengths).
   Supported Ink Types. (Different substrates require different types of inks. For example, photo gloss paper can support most any ink type, but banner vinyl, plastics and mylars require special, quick drying inks).
   Supported Image Qualities. (Different substrates have different absorption qualities. For example, photo gloss paper can support most any image quality, but banner vinyl, plastics and mylars may not be able to support very high DPI settings).

Finishing data includes data describing a vendor's capabilities and parameters for finishing tasks such as laminating a printed document, mounting a document on a substrate (such as foam core or a rigid board), or adding grommets for receiving a rope or other structure.

In addition to the vendor specifications, the rate cards 34 may include data such as:
Press rates—i.e., standard rates to prepare the press for manufacturing the specification (optionally including an amount of waste needed for setup) as well as price per unit area (e.g., square inch or millimeter) for printing the specification (optionally including an amount of waste generated by the printing process).
Substrate adjustments, including, but not limited to, factors that modify press rates (negatively or positively) to compensate for ease or difficulty of printing specific substrates on the press.

As described above in the discussion of FIG. 1, the price engine 10 performs a press type determination 14 that identifies the vendor and/or vendor equipment (i.e., the virtual presses) that are suitable to complete a WFD print job request. The price engine determines the press type by determining all available press types that can fulfill the job, and then it determines a service price 16 for each of the available press types to fulfill the job. The service price determination may consider any or all of the following services:
Press Setup Charge (e.g., flat fee, and any adjustment) that the vendor may require for the specified substrate, which may be calculated using an algorithm such as:
   Press Setup Charge=(Base Press Setup Charge x Substrate Adjustment)+Base Press Setup Charge;
Press Rate−per unit area of the content to be printed multiplied by the number of units (e.g., square inches/millimeters), with any vendor-required adjustment for ink coverage, type of ink used, specified image resolution, and other parameters. This may be calculated using an algorithms such as:
   Unit area of image content=Image Width×Number of Ups×Image Length;
      An “up” is a whole number representing the number of final size impressions (including allowance for image bleed and/or finishing waste) that can fit within an area of substrate. For example, you can get two 11″×8.5″ images on an 11″×17″ sheet. That's known in the industry as 2 up. You can get four 11″×8.5″ images on an 18″×24″ sheet. That's 4 up;
   Press Rate Adjustments (repeat for each available adjustment)=Base Press Rate×Adjustment Factor;
      The adjustment factor may be a user determined or vendor specified adjustment factor for running non-ordinary inks or substrates on the press. It may be a single factor or function of multiple factors;
   Press Rate=Base Press Rate+Adjustment Factors;
   Press Charge=Press Setup Charge+(Press Rate×Number of Unit Areas Imaged); and
   Finishing charge (trimming, sewing, grommeting, folding, etc.).

FIG. 2 depicts an exemplary process of determining a press that may perform a print job. As shown in FIG. 2, when the price engine receives a job request 202, it will determine specifications 204 for the job. Any or all of the specifications may be received from the person who submitted job request, or determined by any suitable methods as described in more detail in the discussion of FIG. 1 above. The price engine will query the vendor specifications 206 to determine which press (or presses) have vendor specifications that match (or most closely match) the specifications of the job request. The parameters of the job specification that may be compared to the vendor specifications include, and are not limited to:
Job quantity (i.e., will the number of impressions required for the job be within the minimum number of impressions and the maximum number of impressions that the vendor will accept for the press);
Ink compatibility (i.e., is the type of ink specified in the job description supported by the vendor and the vendor's press);
Substrate compatibility (i.e., is the type of substrate specified in the job description supported by the vendor and the vendor's press);
Image resolution (i.e., is the specified image resolution supported by the vendor's press); and
Available substrate (i.e., does the vendor carry a desired type of substrate, and will the image content to be printed fit on the vendor's available substrate sizes, considering the vendor's available substrate dimensions and profile). Factors that may be considered include:
   If roll-fed, are the dimensions of the job (e.g., width and/or length, optionally with binding allowances) less than or equal to the roll substrate dimensions; and
   For a cut-sheet job, are the dimensions of the job (e.g., width and/or length, optionally with binding allowances) less than or equal to the cut-sheet substrate dimensions (see signature algorithm, discussed below).

If the vendor's specification is not compatible 210 with the job specification, then the system may continue searching the database for other vendor specifications that are compatible with the job specification. As used in this document, “compatible” does not necessarily mean an exact match, but rather means that the vendor's specification meets enough of the job specification criteria to be able to perform the job.

If the vendor's press specification is determined to be compatible 208 with the job specification, the system will determine a press parameter signature 212 for performing the job the press. The press parameter signature will include a determination of the maximum number of ups that can be imaged by the press considering available substrate parameters, optionally along with other parameters such as:
an impression count reflecting the number of copies required to complete the job;
a calculation of the unit area to be imaged (e.g., the total number of square inches, square centimeters, square millimeters, etc.);
any applicable waste adjustments (such as increases for substrate material, ink, packaging or other items that must be accounted for in the job but which will not make up part of the finished product in the job); and
any applicable rate adjustments (such as volume discounts, preferred customer discounts, etc.).

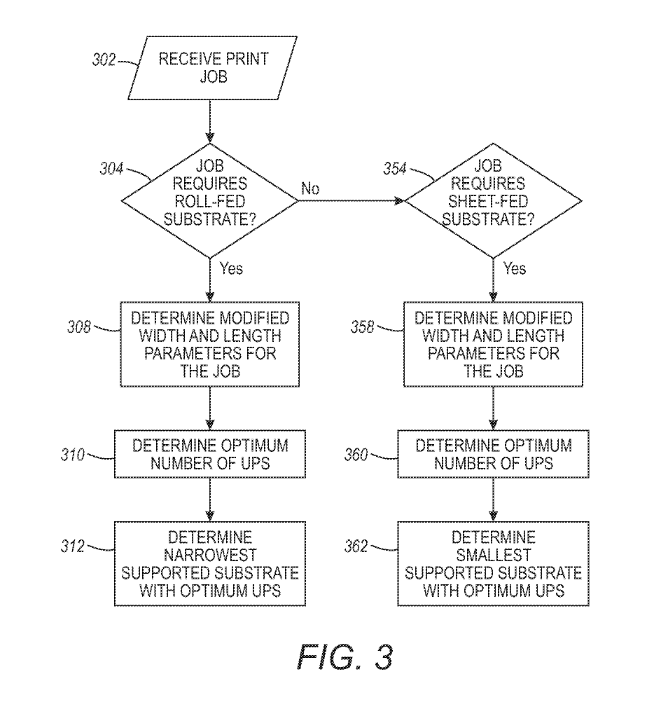

Methods of determining a signature for the press will be described below in the discussion relating to FIG. 3.

Returning to FIG. 2, based on the press profile the system may determine a price for running the job on that press 214. The system may do this either before or after repeating the press selection 216 for other available presses (which may include additional presses for the same vendor, presses from a different vendor, or both). The system does this by: (1) determining a unit price for each function in the job request; (2) optionally adjusting the unit price for one or more of the functions by an adjustment factor, if applicable; (3) adding the unit prices (or adjusted unit prices, if applicable) to yield a total price; and (4) optionally adjusting the total price by an adjustment factor. The system may determine the unit price for a function by querying the vendor's rate sheet for the press. The rate sheet may include prices for certain functions such as:
a price for loading the substrate into the press;
a price for each up (multiplied by the total a number of ups in the job request);
a price per side for trimming any of the sides of the substrate; and
a price per impression or unit area to be imaged, multiplied by the total number of impressions or unit areas.

Other functions that may be considered include, but are not limited to, prepress activities, press activities, inline operation activities, ink supply activities, paper supply activities, postpress activities, finishing activities, and other functions.

Adjustment factors that may be used to adjust any unit price or the total price may include, for example:
any applicable waste adjustments (such as increases for substrate material, ink, packaging or other items that must be accounted for in the job but which will not make up part of the finished product in the job); and
any applicable rate adjustments, such as volume discounts, preferred customer discounts, etc.

The system may determine a price by multiplying the number of ups, impressions, or unit areas of measurement by their applicable price, summing the total, and adjusting the total based on waste adjustments and/or rate adjustment factors. Other calculation methods may be used.

In some cases, this system may determine that only a single press for is available that can perform a requested job. If so, pricing calculations need to be run only for that press. Alternatively, if multiple candidate presses are capable of performing the job, then the system may select a press from the list of candidate presses 218, and it may issue a command to implement (i.e., run) the job 220 on the selected press.

Selection of a press may be accomplished by any suitable means. For example, a list of candidate presses and their prices may be presented to a user on the user interface for user selection. Alternatively, a final press may be selected on an automated basis by any suitable criteria, such as lowest price, closest geographic proximity to the buyer, shortest turnaround time, customer ratings, buyer preference, or other criteria.

FIG. 3 depicts an exemplary process of determining a signature for printing a WFD job on a selected press. The signature is a set of parameters that help achieve an efficient or maximum possible use of available substrate area for the job, with reduced or minimum waste. The system will determine whether the job and/or press will use a roll-fed substrate or a sheet-fed substrate. A roll-fed substrate is one that is continuously fed into the press, such as a roll of newsprint, cloth, or other material. A sheet-fed substrate, sometimes referred to as a cut sheet substrate, is one that is pre-cut and structured as an individual unit. Typically, a roll-fed substrate will be printed with many impressions, and the substrate will be cut after the impressions are made. With a sheet-fed substrate, each sheet may have only one impression or a small number of impressions.

As shown in FIG. 3, when the print engine receives a print job 302 and determines that the job requires a roll-fed substrate 304, the system will review both the width and the length parameters for the print job and create adjusted width and length parameters 308. Each adjusted parameter is a size that expands the required job width or length to account for trimming space, bleed space, banner space, binding space, sewing or seam creation, and/or other features that require extra substrate space beyond the printed image. For example, if the substrate will be trimmed, the system may add ¼ inch, 6 mm, or another distance to each edge to allow for trimming and bleed. If the substrate will be attached to another material (such as binding of a set of blueprints, or sewing of a banner), the system may add 2 inches, 50 mm, or another distance to any edge of the substrate that will be sewn or bound to another material.

The system will then compare the modified width and length parameters with the press's supported roll-fed substrate widths to identify a set of parameters for printing the job to reduce waste. The parameters include: (a) whether to print the image in portrait or landscape; and (b) what width substrate should be used. The method determines whether the print job should be printed in landscape or portrait format and then identifies the narrowest usable supported substrate 310 for that format—i.e., the supported substrate that is closest to and equal or larger than the adjusted length (if printed in portrait) or width (if printed in landscape) parameter. To determine whether to print in portrait or landscape, the print engine will determine an optimum number of ups for the print job 312. To determine the optimum number of ups and identify the narrowest usable substrate, the print engine may perform a calculation such as:
Divide the adjusted image width into the roll-fed substrate width, and save the result in a memory as a first whole number (rounded down);
Divide the adjusted image length into the roll-fed substrate width, and save the result in a memory as a second whole number (rounded down); and
Determine differences between the first and second whole numbers and each of the substrate widths to identify the smallest difference.

The substrate on which the largest number of full size individual impressions can be printed while using the smallest image area will be selected as the narrowest supported substrate. If the smallest difference corresponds to the first whole number, then the image will be printed in landscape format (i.e., the shorter sides of the image will be parallel to the edges of the roll). If the smallest difference corresponds to the first whole number then the image will be printed in landscape format (i.e., the longer sides of the image will be parallel to the edges of the roll). The number of ups is then determined as the maximum number of full sized pieces (plus allowance for image bleed and/or finishing waste) that can be imaged by the press, considering stated image area parameters.

If the print engine determines that the job requires a sheet-fed substrate 354, the system will review both the width and the length parameters for the print job and create adjusted width and length parameters 358. Each adjusted parameter is a size that expands the required job width or length to account for trimming space, bleed space, banner space, binding space, sewing or seam creation, and/or other features that require extra substrate space beyond the printed image. For example, if the substrate will be trimmed, the system may add ¼ inch, 6 mm, or another distance to each edge to allow for trimming and bleed. If the substrate will be attached to another material (such as binding of a set of blueprints, or sewing of a banner), the system may add 2 inches, 50 mm, or another distance to any edge of the substrate that will be sewn or bound to another material.

The system will then compare the modified width and length parameters with the press's supported substrate widths and lengths to identify a set of parameters for printing the job to reduce waste. The parameters include: (a) whether to print the image in portrait or landscape; and (b) what substrate size (width and length) should be used. The method determines whether the print job should be printed in landscape or portrait format and then identifies the overall smallest usable supported substrate 360 for that format—i.e., the supported substrate having the least unused area when the print job is printed on the substrate in either portrait or landscape format. To determine whether to print in portrait or landscape, the print engine will determine an optimum number of ups for the print job 362. To determine the optimum number of ups and identify the smallest usable substrate, the print engine may perform calculations such as:
Divide the adjusted image width into the sheet-fed substrate width, and save the result in a memory as a first whole number (rounded down);
Divide the adjusted image length into the sheet-fed substrate length, and save the result in a memory as a second whole number (rounded down);
Multiply the first and second whole numbers to yield a portrait area calculation;
Divide the adjusted image width into the sheet-fed substrate length, and save the result in a memory as a third whole number (rounded down);
Divide the adjusted image length into the sheet-fed substrate width, and save the result in a memory as a fourth whole number (rounded down);
Multiply the third and fourth whole numbers to yield a landscape area calculation; and
Determine whether the portrait area calculation or the landscape area calculation yields a larger number, and correlate that result to that substrate.

The substrate having a total area that is closest to the correlated result will be selected as the smallest supported substrate. If the portrait area calculation was larger than the landscape area calculation for that substrate, then the image will be printed in portrait format. If the landscape area calculation was larger than the portrait area calculation for that substrate, then the image will be printed in landscape format. The number of ups is determined as the maximum number of full sized pieces (plus allowance for image bleed and/or finishing waste) that can be imaged by the press on a given substrate, considering stated image area parameters

FIG. 4 depicts a block diagram of exemplary internal hardware that may be used to contain or implement program instructions, such as the process steps discussed above in reference to FIGS. 2 and 3, according to embodiments. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 410 and random access memory (RAM) 415 constitute exemplary memory devices or processor-readable storage media.

A controller 420 interfaces with one or more optional tangible, computer-readable memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 430 may permit information from the bus 400 to be displayed on the display 435 in audio, visual, graphic or alphanumeric format. Communication with external devices, such as a printing device, may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A system for selecting a press for wide format digital printing, comprising:
a price engine comprising a processor and a processor-readable storage medium in operable communication with the processor, wherein the processor-readable storage medium contains one or more programming instructions that, when executed, cause the processor to:
receive, from a buyer, a request for a wide format digital print job;
determine a set of job specifications for the print job;
access a vendor database to identify one or more vendor presses that have vendor press specifications that correspond to the job specifications;
for each identified vendor press, access vendor rate card data and use the vendor rate card data and at least a portion of the job specifications to determine a price for performing the print job; and
present the price to the buyer.

2. The system of claim 1, wherein the instructions also cause the processor, in response to a buyer command, to cause the print job to be printed on one of the vendor presses.

3. The system of claim 1, wherein the vendor database further comprises the vendor rate card data.

4. The system of claim 3, further comprising a buyer interface from which the buyer request is received and through which the price is presented to the buyer.

5. The system of claim 1, further comprising a sourcing process service comprising a vendor interface through which a vendor may submit updated vendor specifications to the vendor database.

6. The system of claim 5, wherein:
the vendor database further comprises the vendor rate card data; and
the vendor may submit updated vendor rate card data to the vendor database through the vendor interface.

7. The system of claim 1, wherein the instructions that cause the processor to identify one or more presses comprise instructions that, when executed, cause the processor to compare the job specifications to the vendor press specifications for a plurality of presses in the vendor database to identify at least one press having press profile data and substrate profile data that matches at least a portion of the job specifications,
wherein the press profile data comprises at least one of supported media size, number of ink colors used for full color printing, and pixel density, and
wherein the substrate profile data comprises at least one of supported wide format substrate type, supported ink type for the substrate, and supported image quality for the substrate.

8. The system of claim 1, wherein the instructions that cause the processor to identify a price for each identified press comprise instructions that, when executed, cause the processor to:
identify a plurality of services required for the job based on the job specifications, wherein the services comprise a number of ups;
access the vendor rate card data for an identified press and return a unit price for each of the services;
adjust one or more of the unit prices by any applicable unit price adjustment factors;
total the unit prices to yield a total job price; and
adjust the total price by any applicable total price adjustment factor.

9. The system of claim 8, wherein the instructions that cause the processor to identify a price for each identified press comprise instructions that, when executed, cause the processor to:
determine an optimum number of ups; and
use the optimum number of ups as the number of ups in the identified services.

10. The system of claim 9 wherein the instructions that cause the processor to determine an optimum number of ups comprise instructions to:
identify whether the substrate is a roll-fed substrate or a sheet-fed substrate;
determine which of printing the print job on the substrate in a landscape orientation and printing the print job on the substrate in a portrait orientation will yield less substrate waste; and
determine the maximum number of full sized impressions that can be printed on the substrate.

11. A method, comprising:
receiving, from a buyer, a request for a wide format digital print job;
determining a set of job specifications for the print job;
accessing a vendor database to identify one or more vendor presses that have vendor press specifications that correspond to the job specifications;
for each identified vendor press, accessing vendor rate card data and using the vendor rate card data and at least a portion of the job specifications to determine a price for performing the print job; and
presenting the price for at least one of the identified vendor presses to the buyer.

12. The method of claim 11, also comprising:
receiving a confirmation from the buyer, wherein the confirmation corresponds to one of the prices; and
in response to the confirmation, causing the WFD print job to be printed on the identified vendor presses that corresponds to the confirmation's price.

13. The method of claim 12, wherein the identifying one or more presses that have vendor press specifications that correspond to the job specifications comprises:
comparing the job specifications to the vendor press specifications for a plurality of presses in the vendor database to identify at least one press having press profile data and substrate profile data that matches at least a portion of the job specifications,
wherein the press profile data comprises at least one of supported media size, number of ink colors used for full color printing, and pixel density, and
wherein the substrate profile data comprises at least one of supported wide format substrate type, supported ink type for the substrate, and supported image quality for the substrate.

14. The method of claim 11, wherein the determining a price for performing the print job comprises:
identifying a plurality of services required for the job based on the job specifications, wherein the services comprise a number of ups;
accessing the vendor rate card data for an identified press and return a unit price for each of the services;
adjusting one or more of the unit prices by any applicable unit price adjustment factors;
adding the unit prices to yield a total job price; and
adjusting the total price by any applicable total price adjustment factor.

15. The method of claim 14, wherein the determining a price for performing the print job also comprises:
determining an optimum number of ups; and
using the optimum number of ups as the number of ups in the identified services.

16. The method of claim 15, wherein the determining an optimum number of ups comprises:
identifying whether the substrate is a roll-fed substrate or a sheet-fed substrate;
determining which of printing the print job on the substrate in a landscape orientation and printing the print job on the substrate in a portrait orientation will yield less substrate waste; and
determining the maximum number of full sized impressions that can be printed on the substrate.

17. A system for wide format digital printing, comprising:
a processor and a processor-readable storage medium in operable communication with the processor, wherein the processor-readable storage medium contains one or more programming instructions that, when executed, cause the processor to:
receive, from a buyer, a request for a wide format digital print job;
determine a set of job specifications for the print job;
access a vendor database and compare the job specifications to vendor press specifications for a plurality of presses in the vendor database to identify at least one press having press profile data and substrate profile data that matches at least a portion of the job specifications,
wherein the press profile data comprises at least one of supported media size, number of ink colors used for full color printing, and pixel density, and
wherein the substrate profile data comprises at least one of supported wide format substrate type, supported ink type for the substrate, and supported image quality for the substrate for the identified vendor press, determine a price for performing the print job;
present the price to the buyer; and
in response to a buyer command, cause the print job to be printed the identified vendor press.

18. The system of claim 17, wherein the instructions that cause the processor to identify a price comprise instructions that, when executed, cause the processor to:
identify a plurality of services required for the job based on the job specifications, wherein the services comprise a number of ups;
access the vendor rate card data for the identified press and return a unit price for each of the identified services;
total the unit prices to yield a total job price; and
adjust one or more of the unit prices or the total price by any applicable price adjustment factors.

19. The system of claim 18, wherein the instructions that cause the processor to identify a price for each identified press comprise instructions that, when executed, cause the processor to:
determine an optimum number of ups; and
use the optimum number of ups as the number of ups in the identified services.

20. The system of claim 17 wherein the instructions that cause the processor to determine an optimum number of ups comprise instructions to:
identify whether the substrate is a roll-fed substrate or a sheet-fed substrate;
determine which of printing the print job on the substrate in a landscape orientation and printing the print job on the substrate in a portrait orientation will yield less substrate waste; and
determine the maximum number of full sized impressions that can be printed on the substrate.
